(19) United States
(12) Patent Application Publication
(10) Pub. No.: US 2005/0099392 A1
(43) Pub. Date: May 12, 2005

(54) Mouse having scrolling function

(76) Inventor: Muneki Ishida, Rochester Hills, CA (US)

Correspondence Address: BRINKS HOFER GILSON & LIONE, P.O. BOX 10395, CHICAGO, IL, 60610, US

(21) Appl. No.: 10/943,770

(22) Filed: Sep. 17, 2004

(30) Foreign Application Priority Data
Sep. 22, 2003 (JP) 2003-330111

(51) Int. Cl. G09G 5/08

(52) U.S. Cl. 345/163; 345/164; 345/165; 345/166

(57) ABSTRACT

A mouse having scrolling functions includes a mouse case, a coordinate-inputting unit including a ball provided inside the mouse case, and a sheeted scrolling component composed of, for example a membrane switch, provided on the surface of the mouse case. The scrolling component includes a first scrolling part for vertical scrolling and a second scrolling part for horizontal scrolling.

This application claims the benefit of priority to Japanese Patent Application No. 2003-330111, filed on Sep. 22, 2003, herein incorporated by reference.

### BACKGROUND OF THE INVENTION

1. Field of the Invention

The present invention relates to mice having scrolling functions which are connected with computers and the like and function as coordinate-inputting devices.

2. Description of the Related Art

Conventionally, mice have been used as coordinate-inputting devices by moving on a plane, for example. In order to scroll screens, so-called graphical user interface (GUI) displays used as displaying devices for computers and the like, mice having scrolling functions have also been developed.

Each mouse includes a rotatable wheel supported inside the mouse case for the scrolling function. Rotating the wheel generates signals required for scrolling a computer screen.

In addition to a general vertical-scrolling function, a mouse having a horizontal-scrolling function is proposed in Japanese Unexamined Patent Application Publication No. 2003-108308. In this document, a mouse is provided with a second wheel at the side face of the mouse case for horizontal scrolling.

Other known techniques related to the present invention are a membrane switch disclosed in Japanese Unexamined Patent Application Publication No. 5-217463, a mouse providing a haptic sense, or a sense of force, disclosed in Japanese Unexamined Patent Application Publication No. 4-336316, and a vibrator as means for imparting the sense of force disclosed in Japanese Unexamined Patent Application Publication No. 10-80096.

The mouse disclosed in Japanese Unexamined Patent Application Publication No. 2003-108308 can scroll a screen by rotating the wheels protruding from the faces of the mouse case. Accordingly, the wheels inevitably have relatively large diameters to fit the length of operators' fingers. As a result, the first wheel significantly protrudes upward from the mouse case and thus the overall height of the mouse is large. This hinders the height of the entire device from being reduced.

The mouse disclosed in Japanese Unexamined Patent Application Publication No. 2003-108308 can horizontally scroll the screen when an operator vertically rotates the second wheel with his/her thumb. However, the direction of the scroll does not correspond with the direction of the thumb movement, and thus the high scrolling operability in the horizontal direction is not ensured.

### SUMMARY OF THE INVENTION

An object of the present invention is to provide a mouse having scrolling functions characterized in that substantially no portion protrudes upward from the mouse case.

In order to achieve the object, the mouse preferably includes a mouse case, a coordinate-inputting unit provided inside the mouse case, and a sheeted scrolling component provided on the surface of the mouse case.

With the above-described mouse, an operator can scroll a screen in the desired directions by dragging a finger on the sheeted scrolling component. Since the scrolling component is a flat sheet, the mouse case does not substantially have a protruding portion which causes the height of the entire device to increase.

The mouse preferably includes at least two operation buttons disposed in series on the mouse case, and the scrolling component is preferably disposed between these operation buttons.

In the above-described mouse, those two operation buttons can be used as a left-click button and a right-click button. Since the scrolling component is disposed between these click buttons, the click buttons and the scrolling component can easily be operated.

The scrolling component preferably has a first scrolling part for vertical scrolling and a second scrolling part for horizontal scrolling, and the first scrolling part is preferably orthogonal to the second scrolling part.

In the above-described mouse, the first scroll-controlling part extends in the longitudinal direction of the mouse and allows the vertical scrolling by vertically dragging the finger thereon, and the second scroll-controlling part extends in the lateral direction of the mouse and allows the horizontal scrolling by horizontally dragging the finger thereon. Since the operator can scroll the screen in the vertical and horizontal directions by dragging the fingers on the first and the second scrolling parts on the surface of the mouse case, i.e. on the same plane, the scrolling direction naturally corresponds with the direction of the finger movement.

The second scrolling part is preferably connected with one end, adjacent to the front portion of the mouse case, of the first scrolling part.

With the above-described mouse, the operator drags the finger on the first scroll-controlling part extending from the front end to the back end to vertically scroll the screen, and drags the finger on the second scroll-controlling part extending from the left end to the right end to horizontally scroll the screen. In this manner, both the vertical and horizontal scrolling operations are easily performed. Specifically, the operator can easily operate the second scrolling part only by moving the finger in the lateral direction of the mouse, i.e. right and left, and thus the finger is not strained.

The scrolling component preferably has a part enabling simultaneous scrolling in the vertical and horizontal directions.

The above-described mouse enables vertical scrolling, horizontal scrolling, simultaneous scrolling in both the directions, and oblique scrolling. These scrolling capabilities ensure the excellent scrolling operability.

The scrolling component preferably has clicking parts enabling click operations.

In the above-described mouse, the operator can perform click operations by pressing the clicking parts with a thumb, for example. Since the sheeted scrolling component includes the clicking parts, the mouse does not need click buttons thereon as additional components. This arrangement thus reduces the number of components and simplifies the structure of the mouse. Furthermore, since the scrolling component includes the clicking parts, a large area for the scrolling component can be provided on the surface of the mouse case.

When the scrolling component has the clicking parts, the scrolling component preferably has a first scrolling part for vertical scrolling and a second scrolling part for horizontal scrolling.

With the above-described mouse, the operator can scroll the screen vertically and horizontally by dragging the finger on the first scrolling part and the second scrolling part, respectively, in addition to the click operation on the clicking parts.

The scrolling component preferably includes a membrane switch composed of a top film having top electrodes patterned thereon and a bottom film having bottom electrodes, opposing the respective top electrodes, patterned thereon.

In the above-described mouse, when the operator drags the finger on the membrane switch, the top electrodes on the pressed top film come into contact with the respective bottom electrodes on the bottom film to output continuous signals in response to the finger movement. The scrolling operations are performed in response to the signals. The membrane switch has a resolution of, for example, 1 to 5 mm suitable for scrolling operations.

The mouse preferably includes means for imparting a sense of force, and a controller activating the means during the operation of the scrolling component inside the mouse case.

In the above-described mouse, when the operator drags the finger on the scrolling component to scroll the screen, the controller activates the means for imparting the sense of force to apply a sense of force to the finger dragging the scrolling component. In this manner, the operator can be aware that the scrolling operation is in action by the vibration applied to the finger.

The means preferably includes a vibrator.

With the above-described mouse, when the operator scrolls the screen, the controller activates the vibrator to apply a vibration to the finger dragging on the scrolling component. Accordingly, the operator can be aware that the scrolling operation is in action by the vibration applied to the finger.

As described above, the mouse according to the present invention does not substantially have a protruding portion which causes the height of the entire device to increase.

### BRIEF DESCRIPTION OF THE DRAWINGS

FIG. 1 is a plan view of the mouse having scrolling functions according to a first embodiment of the present invention;

FIG. 2 is a cross-sectional view taken along line II-II in FIG. 1;

FIG. 3 is a partly enlarged cross-sectional view of a substantial portion of a scrolling component included in the mouse according to the first embodiment of the present invention; and

FIG. 4 is a plan view of the mouse according to a second embodiment of the present invention.

### DESCRIPTION OF THE PREFERRED EMBODIMENTS

Preferred embodiments for the mouse having scrolling functions according to the present invention will now be described with reference to the drawings.

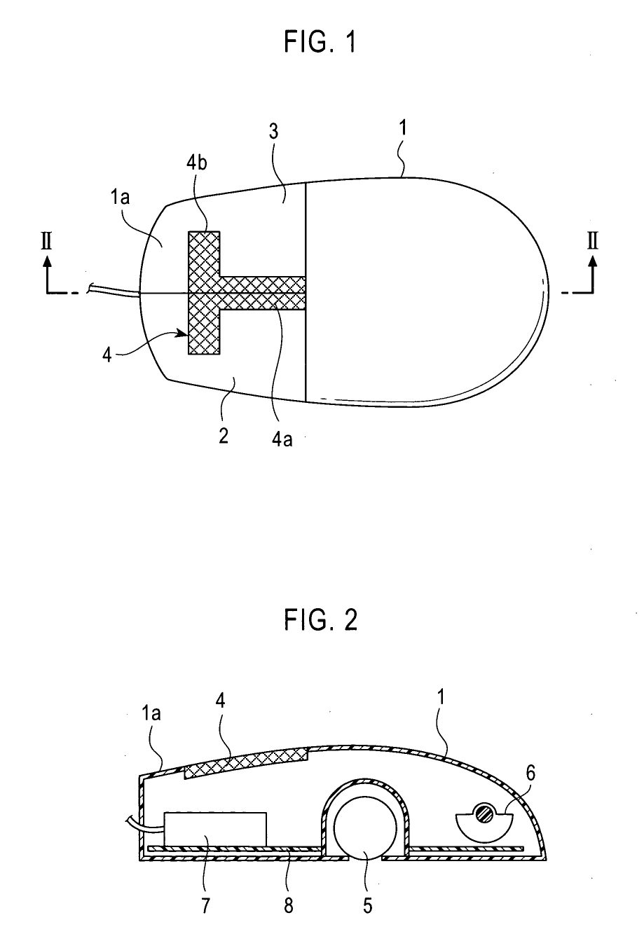

FIG. 1 is a plan view of the mouse according to a first embodiment of the present invention, and FIG. 2 is a cross-sectional view taken along line II-II in FIG. 1.

As shown in FIGS. 1 and 2, the mouse according to the first embodiment includes a mouse case 1, and a coordinate-inputting unit composed of a ball 5 capable of rolling and an encoder (not shown) outputting signals in response to rolling of the ball 5 inside the mouse case 1. The mouse also includes a sheeted scrolling component 4 provided on the surface of the mouse case 1. The mouse further includes at least two operation buttons, i.e. a left-click button 2 and a right-click button 3, disposed in series on the mouse case 1. The scrolling component 4 is disposed between the left-click button 2 and the right-click button 3.

The scrolling component 4 has a first scrolling part 4a for vertical scrolling, i.e. in the longitudinal direction of the mouse in FIG. 1, and a second scrolling part 4b for horizontal scrolling, i.e. in the lateral direction of the mouse in FIG. 1. The first scrolling part 4a is orthogonal to the second scrolling part 4b. The second scrolling part 4b is connected, for example, with one end, adjacent to the front portion 1a of the mouse case 1, of the first scrolling part 4a.

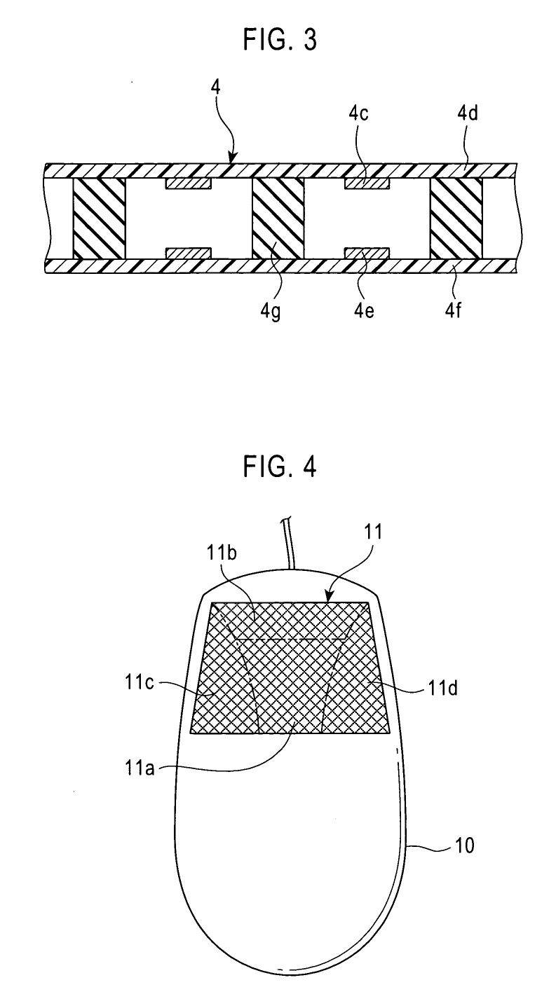

FIG. 3 is a partly enlarged cross-sectional view of a substantial portion of the scrolling component 4 included in the mouse according to the first embodiment of the present invention.

The scrolling component 4 includes a film or membrane switch. This membrane switch is composed of a top film 4d on which top electrodes 4c are patterned, a bottom film 4f on which bottom electrodes 4e opposing the respective top electrodes 4c are patterned, and insulating spacers 4g interposed between the top film 4d and the bottom film 4f.

As shown in FIG. 2, the mouse further includes a vibrator 6, for example, and a controller 7 inside the mouse case 1. The vibrator 6 is means for imparting a sense of force, i.e. haptic sense, that gives a tactile feedback to an operator in response to the amount of the operation of the scrolling component 4. The controller 7 activates the vibrator 6 during the operation of the scrolling component 4. The vibrator 6 and the controller 7 are, for example, disposed on a substrate 8 inside the mouse case 1.

The mouse is connected to a certain displaying device and the like, and is placed on a plane, for example. When the mouse moves on the plane, the ball 5 rolls and inputs the coordinate information to the encoder. The encoder (not shown) then outputs the signals for visualizing the coordinate information on the screen of the displaying device and the like. In this state, the operator can click by pressing the left-click button 2 or the right-click button 3. Moreover, the operator can vertically scroll the screen by dragging his/her finger, for example the forefinger, on the first scrolling part 4a in the longitudinal direction of the mouse in FIG. 1. The operator can also horizontally scroll the screen by dragging the finger on the second scrolling part 4b in the lateral direction of the mouse in FIG. 1.

During these scrolling operations, the signals output in response to the scrolling operations are also sent to the controller 7, and the controller 7 activates the vibrator 6 to apply a vibration to the finger.

According to the mouse of the first embodiment, the operator can scroll the screen vertically and horizontally by dragging the finger on the sheeted scrolling component 4 including a membrane switch. Since the scrolling component 4 is a flat sheet, the mouse case 1 does not substantially have a protruding portion which causes the height of the entire device to increase.

Since the scrolling component 4 is disposed between the left-click button 2 and the right-click button 3, the click buttons 2 and 3 and the scrolling component 4 can easily be operated to ensure the excellent clicking and scrolling operability.

The first scrolling part 4a is disposed orthogonal to the second scrolling part 4b on the surface of the mouse case 1, i.e. on the same plane to perform the vertical scrolling and the horizontal scrolling by moving the finger on the first scrolling part 4a and the second scrolling part 4b, respectively. Since the scrolling direction naturally corresponds with the direction of the finger movement, the operation is intuitive to ensure the excellent scrolling operability.

The arrangement of the second scrolling part 4b connected with one end, adjacent to the front portion 1a of the mouse case 1, of the first scrolling part 4a facilitates both the vertical-scrolling operation by the first scrolling part 4a and the horizontal-scrolling operation by the second scrolling part 4b. Specifically, the operator can easily operate the second scrolling part 4b only by moving the finger right and left. This fatigue-free operation for the finger also ensures the excellent scrolling operability.

The scrolling component 4 includes a membrane switch. The switch has a resolution of 1 to 5 mm to provide many practical applications.

The mouse includes the vibrator 6, i.e. means for imparting a sense of force, inside the mouse case 1. Since the controller 7 activates the vibrator 6 during the scrolling operations, the operator can be aware that the scrolling operation is in action by the vibration applied to the finger. Thus, the excellent scrolling operability is ensured also in this respect.

FIG. 4 is a plan view of the mouse according to a second embodiment of the present invention. The mouse includes a scrolling component 11 provided on the surface of the mouse case 1 which has a first scrolling part 11a for vertical scrolling, a second scrolling part 11b for horizontal scrolling, and clicking parts, for example, a left-clicking part 11c and a right-clicking part 11d. In other words, a single membrane switch included in the scrolling component 11 is partitioned into the above-described parts. The arrangement of other components is the same as the mouse according to the first embodiment.

Similar to the mouse according to the first embodiment, the mouse according to the second embodiment includes the first scrolling part 11a, the second scrolling part 11b, the left-clicking part 11c, and the right-clicking part 11d. Therefore, the same operation as the first embodiment can be performed.

Since the scrolling component 11 has the left-clicking part 11c and the right-clicking part 11d, the mouse according to the second embodiment does not need click buttons on the mouse case 1 as additional components. This arrangement reduces the number of components and simplifies the structure of the mouse, and consequently reduces the production cost. Furthermore, since the scrolling component 11 has the left-clicking part 11c and the right-clicking part 11d, a large area for the scrolling component 11 can be provided on the surface of the mouse case 1.

The mouse according to the second embodiment includes the first scrolling part 11a for vertical scrolling and the second scrolling part 11b for horizontal scrolling in the scrolling component 11. Alternatively, the scrolling component 11 may have a part enabling simultaneous scrolling in the vertical and horizontal directions, i.e. in the oblique direction.

The above-described arrangement enables vertical scrolling, horizontal scrolling, simultaneous scrolling in both the directions, and oblique scrolling. These scrolling capabilities improve the scrolling operability.

1. A mouse having scrolling functions comprising:
a mouse case;
a coordinate-inputting unit provided inside the mouse case; and
a sheeted scrolling component provided on a surface of the mouse case.

2. The mouse according to claim 1, further comprising:
at least two operation buttons disposed in series on the mouse case, wherein
the scrolling component is disposed between the operation buttons.

3. The mouse according to claim 2, wherein
the scrolling component has a first scrolling part for vertical scrolling and a second scrolling part for horizontal scrolling; and
the first scrolling part is orthogonal to the second scrolling part.

4. The mouse according to claim 3, wherein
the second scrolling part is connected with one end, adjacent to a front portion of the mouse case, of the first scrolling part.

5. The mouse according to claim 1, wherein
the scrolling component has a part enabling simultaneous scrolling the vertical and horizontal directions.

6. The mouse according to claim 1, wherein the scrolling component has clicking parts enabling click operations.

7. The mouse according to claim 6, wherein the scrolling component has a first scrolling part for vertical scrolling and a second scrolling part for horizontal scrolling.

8. The mouse according to claim 1, wherein the scrolling component includes a membrane switch composed of a top film having top electrodes patterned thereon and a bottom film having bottom electrodes, opposing the respective top electrodes, patterned thereon.

9. The mouse according to claim 1, further comprising:
means for imparting a sense of force inside the mouse case; and
a controller activating the means during the operation of the scrolling component inside the mouse case.

10. The mouse according to claim 9, wherein the means includes a vibrator.
